(19) United States
(12) Patent Application Publication
(10) Pub. No.: US 2024/0142173 A1
(43) Pub. Date: May 2, 2024

(54) DRYING MACHINE

(71) Applicant: Zhongshan Youxike Electric Appliance Co., Ltd, Zhongshan (CN)

(72) Inventor: Jie LI, Luzhou (CN)

(73) Assignee: Zhongshan Youxike Electric Appliance Co., Ltd, Zhongshan (CN)

(21) Appl. No.: 18/408,315

(22) Filed: Jan. 9, 2024

(30) Foreign Application Priority Data
Nov. 15, 2023 (CN) 202311528185.9

(51) Int. Cl. F26B 21/00; F24F 11/79; F26B 21/04

(52) U.S. Cl. CPC F26B 21/001; F24F 11/79; F26B 21/04

(57) ABSTRACT

The present invention discloses a drying machine, comprising a shell, a door body, a heating device and a blower. A wind inlet of the blower is communicated with a circulation port and the outside simultaneously, a wind outlet of the blower is communicated with a heating wind inlet of a heating cavity, so that the hot air in the drying cavity can enter the drying cavity again after entering the heating cavity through the blower. The post-drying hot air is reintroduced into the heating cavity through the blower, the wind inlet of the blower is communicated with outside at the same time, and new air can be introduced from the outside, so that the hot air with a large amount of water vapors in the drying cavity can be discharged from the air discharge port, which can greatly reduce the energy consumption and improve the work efficiency of drying.

### CROSS-REFERENCE TO RELATED APPLICATIONS

The application claims priority to Chinese patent application No, 202311528185.9, filed on Nov. 15, 2023, the entire contents of which are incorporated herein by reference.

### TECHNICAL FIELD

The present invention relates to a drying machine.

### BACKGROUND

Most of the existing drying machines are simple in design and adopt the design of a working cavity and a drying cavity. A blower of the working cavity at the back side blows air to heating wires, and hot air enters the drying cavity through a wind outlet between the working cavity and the drying cavity, so that objects in the drying cavity are dried by the hot air. A front side of the drying cavity is provided with opposite glass doors, and there are gaps between the glass doors, thus the post-drying air leaves the drying cavity through the gaps. Although the design purpose of drying can be achieved with the above design, the energy consumption is relatively high and the drying efficiency is low. Therefore, a drying machine which can recycle the post-drying air, save energy and protect the environment, and improve the drying efficiency is needed.

The present invention is researched and proposed aiming at the deficiencies of the existing technology.

### SUMMARY

In view of the shortcomings of the high energy consumption and the low drying efficiency of the drying machine in the existing technology mentioned above, the present invention adopts the following technical solutions to solve the technical problems. A drying machine comprises a shell, a door body, a heating device and a blower, wherein the shell inside is provided with a drying cavity, the door body is connected with the shell for closing the drying cavity, the shell is also provided with a heating cavity communicated with the drying cavity. The heating device is arranged in the heating cavity, the shell is provided with an air discharge port and a circulation port both communicated with the drying cavity, and the shell is provided with a heating wind inlet communicated with a heating cavity. The wind inlet of the blower is communicated with both the circulation port and the outside, and a wind outlet of the blower is communicated with the heating wind inlet of the heating cavity, so that the hot air from the drying cavity enters the heating cavity through the blower and then enters the drying cavity again.

The drying machine as mentioned above, a side partition plate is provided at a left side and/or a right side of the shell, a dispersion cavity is arranged between the side partition plate and the shell, and the dispersion cavity is communicated with the heating cavity. Multiple hot wind outlet holes communicated with the drying cavity are arranged on the side partition plate, so that the hot air in the heating cavity enters the drying cavity after passing through the dispersion cavity.

The drying machine as mentioned above, the hot wind outlet holes are distributed on the side partition plates along a horizontal direction and a vertical direction.

The drying machine as mentioned above, a back partition plate is arranged in the shell, the circulation port is arranged on the back partition plate, a mounting shell used for mounting the blower is arranged on the back partition plate, and a mixing cavity communicated with the circulation port is arranged in the mounting shell. An air supply port communicated with the outside is arranged on the mounting shell, and the mixing cavity in the mounting shell is communicated with the wind inlet of the blower.

The drying machine as mentioned above, a heating shell is arranged at a lower part of the rear side of the back partition plate, the heating cavity is arranged between the heating shell and the back partition plate, the heating wind inlet is arranged oil the heating shell, and the back partition plate is provided with an opening communicating both the heating cavity and the dispersion cavity.

The drying machine as mentioned above, a back cover plate is arranged at a back side of the shell, a hollow cavity is arranged between the back cover plate and the back partition plate, the blower and the heating shell are arranged in the hollow cavity, and an air inlet communicated with the outside and the hollow cavity is arranged on the back cover plate.

The drying machine as mentioned above, the air discharge port is arranged on both sides of the door body.

The drying machine as mentioned above, the drying cavity inside is provided with a shelf for placing objects to be dried.

The drying machine as mentioned above, the shelf contains: two groups of side support frames connected to the left and right sides of the drying cavity, and multi-groups of layer frames arranged between the two groups of side support frames.

The drying machine as mentioned above, the shell is provided with a handle which is convenient for handling.

The present has the following beneficial effects.
1. In the present invention, the wind inlet of the blower is communicated with both the circulation port and the outside, and the wind outlet of the blower is communicated with the heating wind inlet of the heating cavity, so that the hot air in the drying cavity can enter into the drying cavity again after entering the heating cavity through the blower. The post-drying hot air is reintroduced into the heating cavity through the blower, the wind inlet of the blower is communicated with the outside at the same time, and new air can be introduced from the outside, so that the hot air with a large amount of water vapors in the drying cavity can be discharged from the air discharge port, which can greatly reduce the energy consumption and improve the work efficiency of drying.
2. Multiple hot wind outlet holes communicated with the drying cavity are arranged on the side partition plate, the hot air in the heating cavity enters into the dying cavity after passing through the dispersion cavity, and the hot air will disperse and then enter into the drying cavity, so that the hot air is evenly distributed in the drying cavity and thus to avoid uneven temperature in the drying cavity;
3. The heating shell is arranged on the lower part of the back side of the back partition plate, which makes full use of the upward movement of the hot air thus to reduce the energy consumption of the blower;
4, The back cover plate can play the roles of protection and heat preservation. The cold air first enters the hollow cavity, and the air in the hollow cavity can be preheated by the heat emitted by the heating shell, and then enters the wind inlet of the blower to further save energy.

### BRIEF DESCRIPTION OF DRAWINGS

The present invention will be further illustrated below in combined with the accompanying drawings and the detailed descriptions of embodiments.

FIG. 1 is a schematic structural view of a drying machine according to the present invention:

FIG. 2 is a schematic back view of the drying machine according to the present invention;

FIG. 3 is a schematic full cross-sectional view along an A-A line in FIG. 2;

FIG. 4 is a schematic full cross-sectional view along a B-B line in FIG. 2;

FIG. 5 is a first schematic exploded view of the drying machine according to the present invention;

FIG. 6 is a second schematic exploded view of the drying machine according to the present invention;

FIG. 7 is a third schematic exploded view of the drying machine according to the present invention:

FIG. 8 is a schematic structural view that a door body of the drying machine is hidden according to the present invention;

FIG. 9 is a schematic stereoscopic cross-sectional view of the drying machine according to the present invention.

### DETAILED DESCRIPTION OF THE EMBODIMENTS

The embodiments of the present invention will be described in detail hereafter in conjunction with the accompanying drawings.

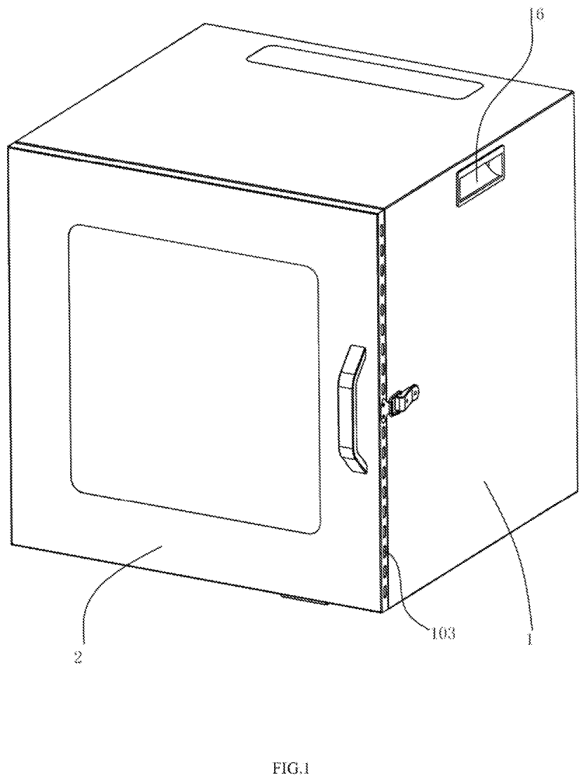

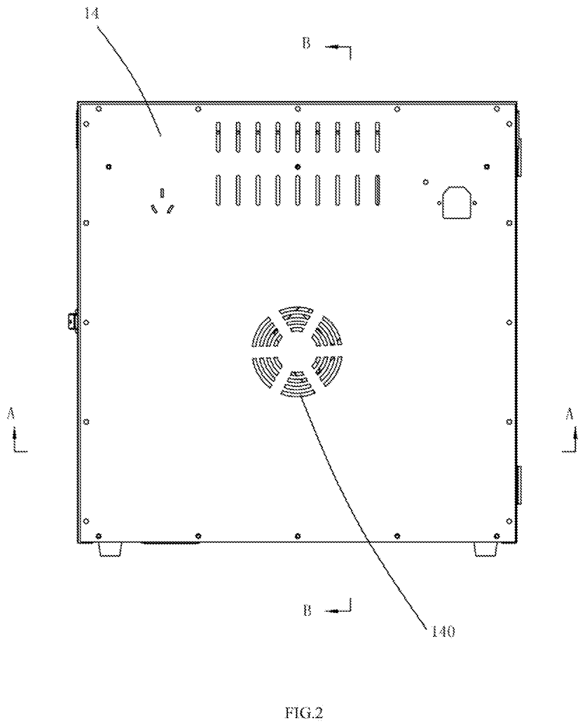

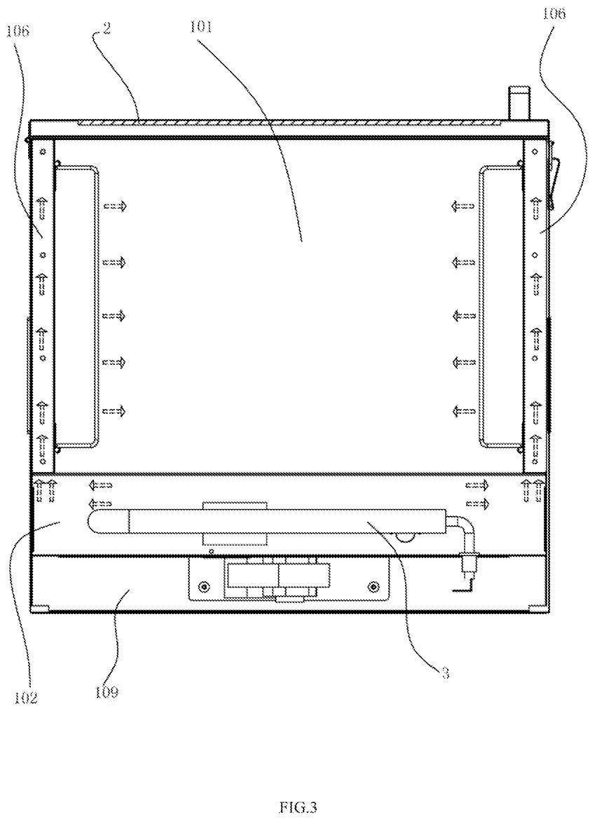

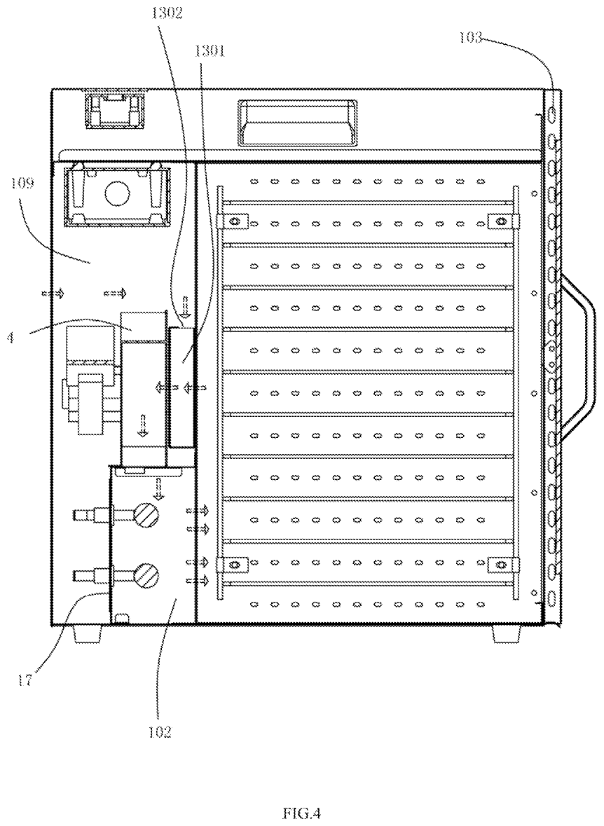

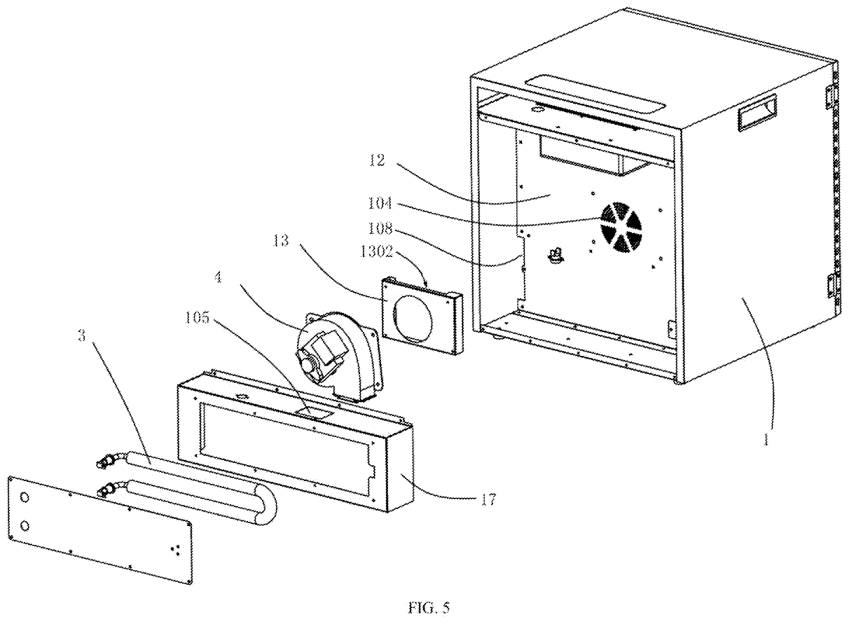

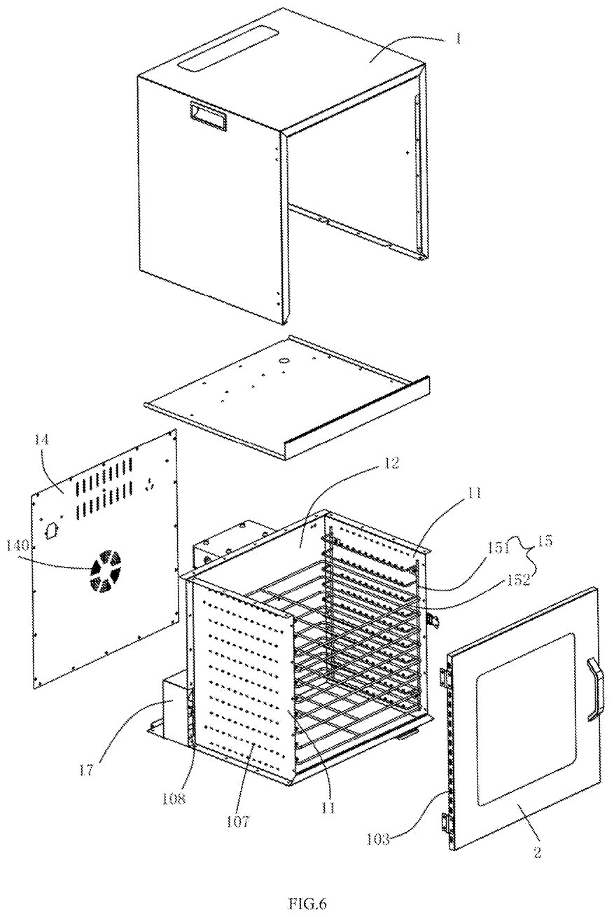

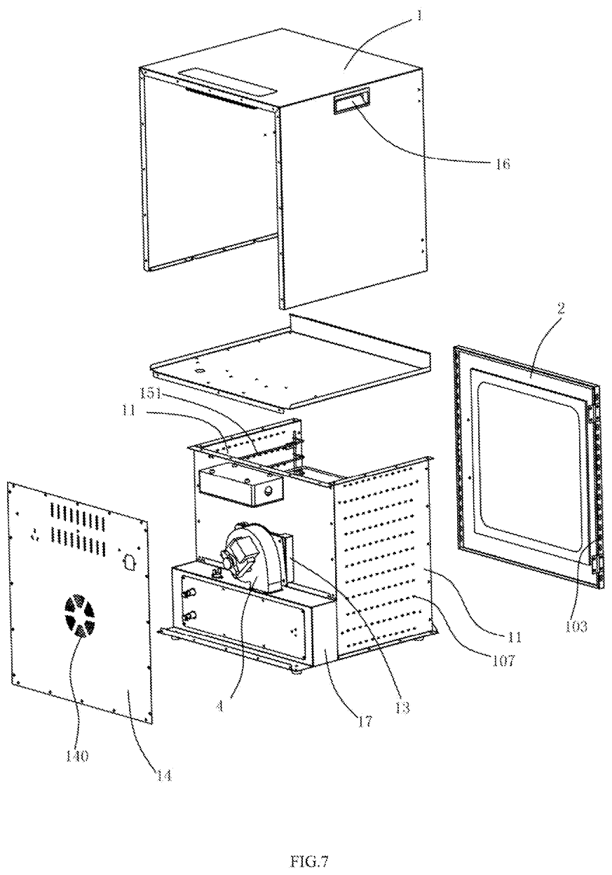

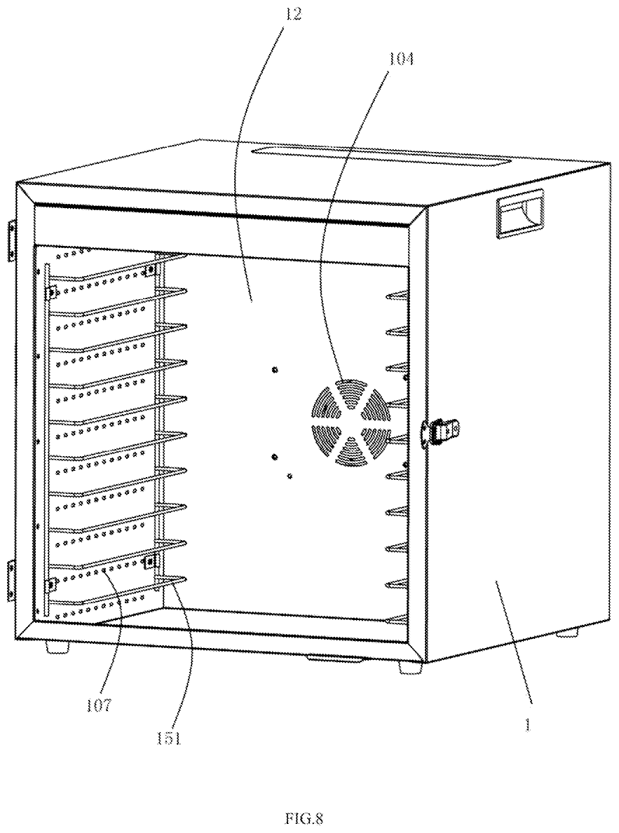

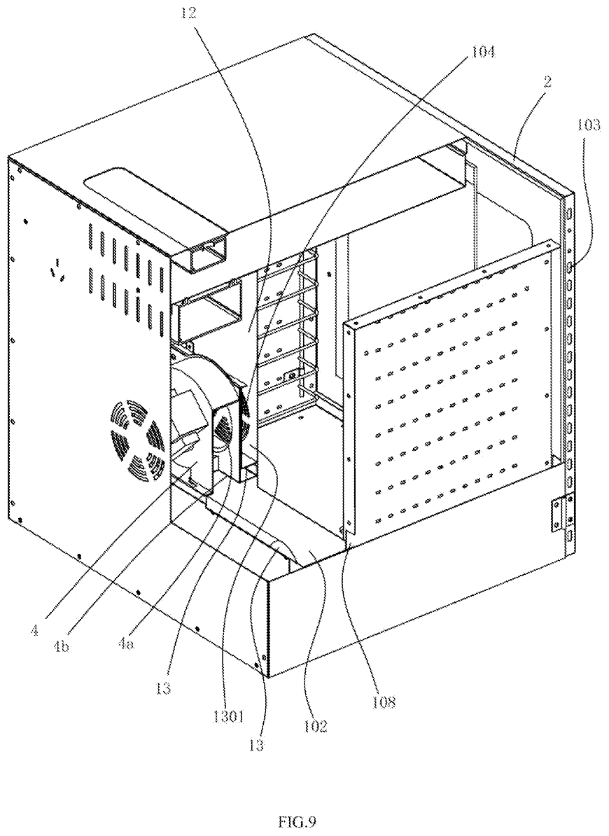

As shown in FIG. 1 to FIG. 9, an embodiment of the present invention provides a drying machine, comprising a shell 1, a door body 2, a heating device 3 and a blower 4, The shell 1 inside is provided with a drying cavity 101, the door body 2 is connected with the shell 1 and used for closing the drying cavity 101, and the shell 1 is also provided with a heating cavity 102 communicated with the drying cavity 10l. The heating device 3 is arranged in the heating cavity 102, the shell 1 is provided with an air discharge port 103 and a circulation port 104 both communicated with the drying cavity 101, and the shell 1 is provided with a heating wind inlet 105 communicated with a heating cavity 102. A wind inlet 4a of the blower 4 is communicated with both the circulation port 104 and the outside, and a wind outlet 4b of the blower 4 is communicated with the heating wind inlet 105 of the heating cavity 102, so that the hot air from the drying cavity 101 enters the heating cavity 102 through the blower 4 and then enters the drying cavity 101 again. In the present invention, the wind inlet of the blower is communicated with both the circulation port and the outside, and the wind outlet of the blower is communicated with the heating wind inlet of the heating cavity, so that the hot air in the drying cavity can enter the drying cavity again after entering the heating cavity through the blower. The post-drying hot air is reintroduced into the heating cavity through the blower, the wind inlet of the blower is communicated with the outside at the same time, and new air can be introduced from the outside, so that the hot air with a large amount of water vapors in the drying cavity can be discharged from the air discharge port, which can greatly reduce the energy consumption and improve the work efficiency of drying.

In the embodiment of the present invention, a side partition plate 11 is provided at a left side and/or a right side of the shell 1, a dispersion cavity 106 is arranged between the side partition plate 11 and the shell 1, and the dispersion cavity 106 is communicated with the heating cavity 102. Multiple hot wind outlet holes 107 communicated with the drying cavity 101 are arranged on the side partition plate 11, so that the hot air in the heating cavity 102 enters the drying cavity 101 after passing through the dispersion cavity 106. Since the multiple hot wind outlet holes communicated with the drying cavity are arranged on the side partition plate, the hot air in the heating cavity enters into the drying cavity after passing through the dispersion cavity, thus the hot air will enter into the drying cavity after being dispersed, so that the hot air is evenly distributed in the drying cavity, and thus to avoid uneven temperature in the drying cavity.

In the embodiment of the present invention, the hot wind outlet holes 107 are distributed on the side partition plate 11 in a horizontal direction and a vertical direction, so that the hot air is evenly distributed in the drying cavity.

In the embodiment of the present invention, a back partition plate 12 is arranged in the shell 1, the circulation port 104 is arranged on the back partition plate 12, and a mounting shell 13 for mounting the blower 4 is arranged on the back partition plate 12. A mixing cavity 1301 communicated with the circulation port 104 is arranged in the mounting shell 13, an air supply port 1302 communicated with the outside is arranged on the mounting shell 13, and the mixing cavity 1301 in the mounting shell 13 is communicated with the wind inlet 4a of the blower 4. This design used above has the advantages of simple structure and easy assembly.

In the embodiment of the present invention, the heating shell 17 is arranged on a lower part of a back side of the back partition plate 12, the heating cavity 102 is arranged between the heating shell 17 and the back partition plate 12, the heating wind inlet 105 is arranged upon the heating shell 17, and the back partition plate 12 is provided with an opening 108 communicating both the heating cavity 102 and the dispersion cavity 106. The heating shell is arranged on the lower part of the back side of the back partition plate, which makes frill use of the upward movement characteristic of the hot air, thus to reduce the energy consumption of the blower.

In the embodiment of the present invention, a back cover plate 14 is arranged at a backside of the shell 1, a hollow cavity 109 is arranged between the back cover plate 14 and the back partition plate 12, the blower 4 and the heating shell 17 are arranged in the hollow cavity 109, and the back cover plate 14 is provided with an air inlet 140 communicating with the outside and the hollow cavity 109. The back cover plate can play the roles of protection and heat preservation. After the cold air first enters the hollow cavity, the air in the hollow cavity can be preheated by the heat emitted by the heating shell and then enters the wind inlet of the blower to further save energy.

In the embodiment of the present invention, the air discharge port 103 is arranged on both sides of the door body 2, which has the advantage of convenient processing.

In, the embodiment of the present invention, the drying cavity 101 inside is provided with a shelf 15 for placing objects to be dried. The shelf 15 contains: two groups of side support frames 151 connected to the left and right sides of the drying cavity 101, and multi-groups of layer frames 152 arranged between the two groups of side support frames 151. It is convenient to dry objects through the shelf.

In the embodiment of the present invention, the shell 1 is provided with a handle 16 which is convenient for handling.

The technical content of the present invention is further described only by the way of the embodiments as mentioned above, so that readers can understand more easily, but it does not mean that the embodiments of the present invention are limited thereto. Any technical extensions or re-creations based on the present invention are protected by the present invention. The protection scope of the present invention shall be subject to the claims.

What is claimed is:

1. A drying machine, comprising a shell, a door body, a heating device and a blower, wherein
the shell inside is provided with a drying cavity, the door body is connected with the shell for closing the drying cavity;
the shell is also provided with a heating cavity communicated with the drying cavity, the heating device is arranged in the heating cavity;
the shell is provided with an air discharge port and a circulation port both communicated with the drying cavity;
the shell is provided with a heating wind inlet communicated with a heating cavity,
a wind inlet of the blower is communicated with both the circulation port and the outside, and
a wind outlet of the blower is communicated with the heating wind inlet of the heating cavity, so that the hot air from the drying cavity enters the heating cavity through the blower and then enters the drying cavity again.

2. The drying machine according to claim 1, wherein a side partition plate is provided at a left side and/or a right side of the shell, a dispersion cavity is arranged between the side partition plate and the shell, the dispersion cavity is communicated with the heating cavity, and multiple hot wind outlet holes communicated with the drying cavity are arranged on the side partition plate, so that the hot air in the heating cavity enters the drying cavity after passing through the dispersion cavity.

3. The drying machine according to claim 2, wherein the hot wind outlet holes are distributed on the side partition plates along a horizontal direction and a vertical direction.

4. The drying machine according to claim 2 wherein a back partition plate is arranged, in the shell, the circulation port is arranged on the back partition plate, a mounting shell used for mounting the blower is arranged on the back partition plate, a mixing cavity communicated with the circulation port is arranged in the mounting shell, an air supply port communicated with the outside is arranged on the mounting shell, and the mixing cavity in the mounting shell is communicated with the wind, inlet of the blower.

5. The drying machine according to claim 3, wherein a back partition plate is arranged in the shell, the circulation port is arranged on the back partition plate, a mounting shell used for mounting the blower is arranged on the back partition plate, a mixing cavity communicated with the circulation port is arranged in the mounting shell, an air supply port communicated with the outside is arranged on the mounting shell, and the mixing cavity in the mounting shell is communicated with the wind inlet of the blower.

6. The drying machine according to claim 4, wherein a heating shell is arranged at a lower part of the rear side of the back partition plate, the heating cavity is arranged between the heating shell and the back partition plate, the heating wind inlet is arranged upon the heating shell, and the back partition plate is provided with an opening communicating both the heating cavity and the dispersion cavity.

7. The drying machine according to claim 5, wherein a heating shell is arranged at a lower part of the rear side of the back partition plate, the heating cavity is arranged between the heating shell and the back partition plate, the heating wind inlet is arranged upon the heating shell, and the back partition plate is provided with an opening communicating both the heating cavity and the dispersion cavity.

8. The drying machine according to claim 6, wherein a back cover plate is arranged at a back side of the shell, a hollow cavity is arranged between the back cover plate and the back partition plate, the blower and the heating shell are arranged in the hollow cavity, and an air inlet communicated with the outside and the hollow cavity is arranged on the back cover plate.

9. The drying machine according to claim 7, wherein a back cover plate is arranged at a back side of the shell, a hollow cavity is arranged between the back cover plate and the back partition plate, the blower and the heating shell are arranged in the hollow cavity, and an air inlet communicated with the outside and the hollow cavity is arranged on the back cover plate.

10. The drying machine according to claim 2, wherein the air discharge port is arranged on both sides of the door body.

11. The drying machine according to claim 2, wherein the drying cavity inside is provided with a shelf for placing objects to be dried.

12. The drying machine according to claim 11, wherein the shelf contains: two groups of side support frames connected to the left and right sides of the drying cavity, and multi-groups of layer frames arranged between the two groups of side support frames.

13. The drying machine according to claim 1, wherein the shell is provided with a handle which is convenient for handling.
